(19) United States
(12) Patent Application Publication
(10) Pub. No.: US 2024/0173908 A1
(43) Pub. Date: May 30, 2024

(54) DISPENSING DEVICE AND METHODS THEREOF

(71) Applicant: 3M INNOVATIVE PROPERTIES COMPANY, St. Paul, MN (US)

(72) Inventors: Thomas Q. Chastek, St. Paul, MN (US); Mark E. Napierala, St. Paul, MN (US); Mark F. Schulz, Lake Elmo, MN (US); Ross E. Behling, Woodbury, MN (US); Ilya A. Salnikov, Inver Grove Heights, MN (US); Richard P. Lovelien, Baldwin, WI (US)

(21) Appl. No.: 18/283,655

(22) PCT Filed: Mar. 9, 2022
(86) PCT No.: PCT/IB2022/052113

§ 371 Date: Sep. 22, 2023

Related U.S. Application Data
(60) Provisional application No. 63/167,866, filed on Mar. 30, 2021.

(51) Int. Cl. B29C 48/52; B29C 48/535; B29C 64/118; B29C 64/209; B33Y 30/00

(52) U.S. Cl. CPC B29C 48/52; B29C 48/535; B29C 64/118; B29C 64/209; B33Y 30/00

(57) ABSTRACT

Provided is an apparatus for dispensing a composition that includes a barrel having an inlet and outlet, an extrusion screw, and a drive mechanism operatively coupled to the extrusion screw. The extrusion screw includes a shaft having a shank end for connection to the drive mechanism and a distal end opposite the shank end. A first helical flight extends around a first section of the shaft, and a second helical flight extends around a second section of the shaft. The second section is located distal to the first section and the first helical flight has a nominal outer radius less than that of the second helical flight, and optionally the first helical flight has a pitch shorter than that of the first helical flight.

### FIELD OF THE INVENTION

Provided are dispensers for polymeric compositions, and particularly those capable of continuously dispensing polymeric compositions, along with related methods and dispensing systems.

### BACKGROUND

Single screw dispensers are commonly used as mechanisms for processing polymeric materials in continuous manufacturing and converting operations. These machines use a rotating screw received within a cylindrical barrel. The barrel includes an inlet, typically located on the top of the barrel and an outlet located at a distal end of the barrel. Along its length, the barrel can include one or more resistive heating elements, which can be precisely controlled to assist in heating the contents of the barrel.

These dispensers typically receive and convert a feed stock, typically of polymer pellets or powder. The feed stock can include one or more thermoplastic resins that are solid at ambient temperature. After being fed into the dispenser through the inlet, the feed stock is heated above its melt temperature through a combination of thermal conduction along the heated walls of the barrel and the high pressure and friction generated by the screw rotation. The feed stock is thus metered, melted, and mixed as it is conveyed along the length of the barrel by the rotating screw and is eventually expelled from the distal end of the barrel through the outlet.

The screw can be operated by a motorized drive assembly and gearbox, and temperature controllers are connected to heating and/or cooling elements along one or more control zones along the barrel to maintain a desired temperature profile based on characteristics of the composition being dispensed and the application at hand.

### SUMMARY

Many technical advantages can derive from using a dispensing devices that accept filament compositions. Use of a filament as a feed stock is especially convenient when seeking to dispense adhesive compositions, including pressure-sensitive adhesive compositions. In these applications, the filament can have a core-sheath form factor, in which a tacky first component is sheathed in a non-tacky second component to simplify handling and feeding into the dispenser. Within the dispenser, the tacky and non-tacky components are melted and mixed and eventually expelled as a homogenous composition at the distal end of the dispenser.

Filaments differ significantly from pellets in how they feed. The filaments are much larger than pellets and do not pack between inlet flights. The form factor of filaments presents a number of technical problems, at least some of which are unexpected. In this process, there is a need for the filament to be firmly gripped and consistently pulled into the dispenser. If this does not happen, the throughput might be improper, or the external motorized feed mechanism could jam. Feed wheel jamming was discovered to be a common malfunction in conventional filament dispensers. Even with care taken to meter the filament into the dispenser, jamming can still occasionally occur. From a customer standpoint, even intermittent jamming can present a significant barrier to adoption.

Another failure mode is that feeding of the filament into the dispenser might inadvertently stop. This can happen, for example, if the screw does not have a sufficiently grip on the filament. In some cases the filament may even fall out of the inlet, and require operator intervention to restore proper feeding into the inlet.

Provided herein is a dispensing device using an extrusion screw having a reduced radius (i.e., screw flight height), and optionally a reduced pitch, along its inlet section. The reduced diameter creates an appropriately sized gap between the screw and barrel, which optimally matches the filament diameter and can act as an aggressive nip to pull a soft to medium-soft thermoplastic filament into the dispenser. The reduced pitch at the inlet can moderate the rate at which the filament is pulled into the barrel, so that it matches the extrusion rate of the dispenser, thereby avoiding a rolling ball at the inlet that inhibits further feeding.

A rolling ball situation occurs when material enters the inlet and is partially masticated, but does not proceed down the length of the screw. Instead, it moves back out of the inlet, creating a ball-shaped mass of masticated material. This mass of material can act as a barrier between the screw and incoming filament. New material stops feeding properly, either because the ball of material no longer enters the inlet, or because the filament is no longer being pulled in. In some cases, the filament can fall out of the dispenser, and thereby halt feeding even when the screw continues to consume material from the rolling ball.

This provided dispensing device can reduce or even eliminate the need for external motorized feed mechanisms, simplify the dispensing system, while making it more reliable and economical.

In a first aspect, an extrusion screw is provided. The extrusion screw comprises: a shaft having a shank end for connection to a drive mechanism and a distal end opposite the shank end: a first helical flight extending around a first section of the shaft: and a second helical flight extending around a second section of the shaft, wherein the second section is located distal to the first section and wherein the first helical flight has a nominal outer radius less than that of the second helical flight.

In a second aspect, an apparatus for dispensing a composition is provided, the apparatus comprising: a barrel having an inlet and outlet; the extrusion screw; and the drive mechanism operatively coupled to the shank end.

In a third aspect, a method of dispensing a composition using the apparatus is provided, the method comprising: feeding the composition into the inlet of the barrel:

rotating the extrusion screw such that the first helical flight pulls the composition through the inlet into the first section of the barrel and the second helical flight conveys the composition through the second section where it is melted and expelled through the outlet.

### BRIEF DESCRIPTION OF THE DRAWINGS

FIG. 1 is a schematic of a dispensing system according to one exemplary embodiment.

FIG. 2 is a cut-away view of a dispensing apparatus that can be used in the dispensing system of FIG. 1 in an exemplary embodiment.

FIG. 3 is an elevational, side view of a screw according to one embodiment used in the dispensing apparatus of FIG. 2.

FIG. 4 is a photograph showing an elevational, side view of a screw according to an alternative embodiment.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### Definitions

“Ambient temperature” means at a temperature of 22 degrees Celsius.

“Nominal” refers to an average.

“Non-tacky” refers to a material that passes a “Self-Adhesion Test”, in which the force required to peel the material apart from itself is at or less than a predetermined maximum threshold amount, without fracturing the material. The Self-Adhesion Test is described in International Patent Publication No. WO 2019/164678 (Nyaribo, et al.) and is typically performed on a sample of the sheath material to determine whether or not the sheath is non-tacky.

### DETAILED DESCRIPTION

As used herein, the terms “preferred” and “preferably” refer to embodiments described herein that can afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises”, and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and if so, are from the perspective observed in the particular drawing. These terms are used only to simplify the description, however, and not to limit the scope of the invention in any way.

Reference throughout this specification to “one embodiment,” “certain embodiments.” “one or more embodiments” or “an embodiment” means that a particular feature, structure, material, or characteristic described relating to the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Where applicable, trade designations are set out in all uppercase letters.

A dispensing apparatus, along with systems and methods thereof, are described herein for the continuous dispensing of a polymeric feed stock in molten form. The dispensed compositions can have a Shore A hardness in the range of from 10 to 70, or in some cases, even less than a Shore A hardness of 10. These compositions are optionally pressure-sensitive adhesives. The dispensing apparatus can be made very compact.

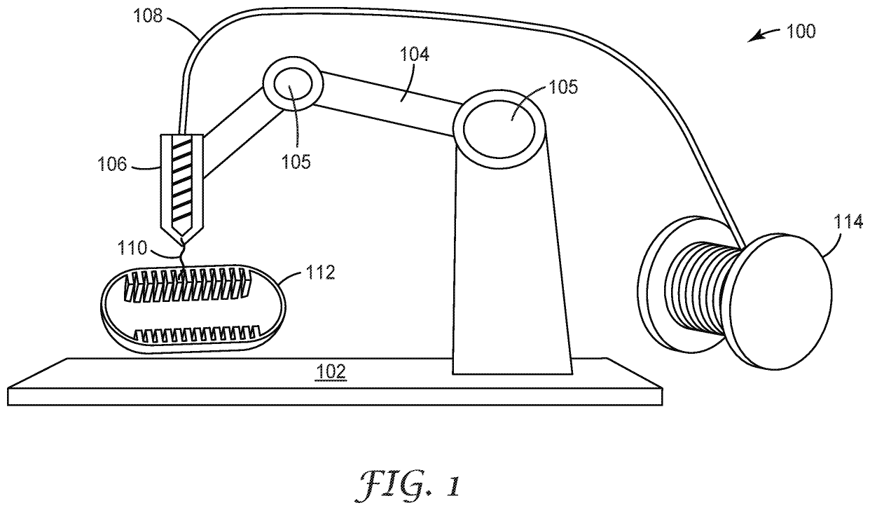

FIG. 1 is a schematic illustration of an exemplary dispensing system hereinafter broadly referred to by the numeral 100. The dispensing system 100 includes a dispensing apparatus 102 mounted to the end of a movable arm 104. The movable arm 104 is affixed to a base 106, which can be part of a table or other platform. The movable arm 104 can have any number of joints 105 to allow the dispensing apparatus 102 to be translated and rotated in up to six degrees of freedom. The movable arm 104, which may be manually or robotically controlled, allows the dispensing apparatus 102 to dispense an extruded composition with precision and reproducibility over a wide range of locations relative to the base 106.

Optionally and as shown, the dispensing system 100 includes a filament adhesive 108 that can be continuously fed into the dispensing apparatus 102 as shown in FIG. 1. The filament adhesive 108 can be continuously unwound from a spool 114 as shown. The location of the spool 114 relative to other components of the dispensing system 100 is not critical and can mounted where convenient. For instance, the spool 114 can be fixtured to the base 106 or a structure to which the base 106 is commonly mounted.

The dispensing apparatus 102 of FIG. 1 is being shown dispensing a molten composition 110 in hot melt form onto the bonding surface of an exemplary substrate 112. The substrate 112 need not be limited and can be, for example, an industrial part to be adhesively coupled to an assembly. As an option, the substrate 112 can be mounted onto the base 106, thereby providing a spatial point of reference for positioning of the dispensing apparatus 102. This can be especially useful in an automatic process, where a computer is used to control the position and orientation of the dispensing apparatus 102.

Advantageously, dispensing of the molten composition 110 can be automated or semi-automated, thus requiring little or no intervention by a human operator. It is possible, for example, to dispense the molten composition 110 onto the substrate 112 according to instructions provided by a computer based on a pre-determined pattern. The pre-determined pattern can be 2-dimensional (along a planar surface) or 3-dimensional (along a non-planar surface). The pre-determined pattern can be represented by digitized model on the computer, enabling the pre-determined pattern to be customized for any number of substrates.

Applications for which the dispensing system 100 or dispensing apparatus 102 might be used include those described in International Patent Publication No. WO 2020/174396 (Napierala, et al.).

The dispensing system 100 of FIG. 1 is specifically adapted to receive the filament adhesive. Filament adhesives are tacky substances provided in a continuous rope-like configuration. The filament adhesive preferably has a uniform cross-sectional area. Advantageously, a filament adhesive can be fed continuously from a spool into a dispensing apparatus, such as a dispensing apparatus.

Particularly useful filament adhesives have a core-sheath filament configuration. Core-sheath filament materials have a configuration in which a first material (i.e., the core) is surrounded by a second material (i.e., the sheath). Preferably, the core and the sheath are concentric, sharing a common longitudinal axis. The ends of the core need not be surrounded by the sheath. Advantageously, the non-tacky sheath prevents the filament adhesive 108 from sticking to itself, thereby enabling convenient storage and handling of the filament adhesive 108 on the spool 114.

The diameter of the core-sheath filament is not particularly restricted. Factors that influence the choice of filament diameter include the size constraints on the adhesive dispenser, desired adhesive throughput, and precision requirements for the adhesive application. The core-sheath filament can comprise an average diameter of 1 millimeter to 20 millimeters, 3 millimeters to 13 millimeters, 6 millimeters to 12 millimeters, or in some embodiments, less than, equal to, or greater than 1 millimeter, 2, 3, 4, 5, 6, 7, 8, 9, 10, 11, 12, 13, 14, 15, 16, 17, 18, 19, or 20 millimeters. The filament adhesive 108 can be a stock item and provided in any composition and length suitable for the application.

The dispensing methods described herein offer many potential technical advantages. These technical advantages include retention of adhesive properties after dispensing, low volatile organic compound (VOC) characteristics, avoiding die cutting, design flexibility, achieving intricate non-planar bonding patterns, printing on thin and/or delicate substrates, and printing on irregular and/or complex topologies.

Core sheath filament adhesives according to the present disclosure can be made using any known method. In an exemplary embodiment, these filament adhesives are made by extruding molten polymers through a coaxial die. Technical details, options and advantages concerning the aforementioned core sheath filament adhesives are described in International Patent Publication No. WO 2019/164678 (Nyaribo, et al.)

It is to be understood that the provided dispensing apparatus 102 need not be limited to the dispensing system 100 shown in FIG. 1. In other embodiments, the dispensing apparatus 102 can have a fixed location and/or orientation. Further, the dispensing apparatus 102 can accept feed stock other than filament adhesives: for example, the dispensing apparatus 102 can accept polymer pellets, flakes, or granules through a hopper or other feed mechanism known to those skilled in the art.

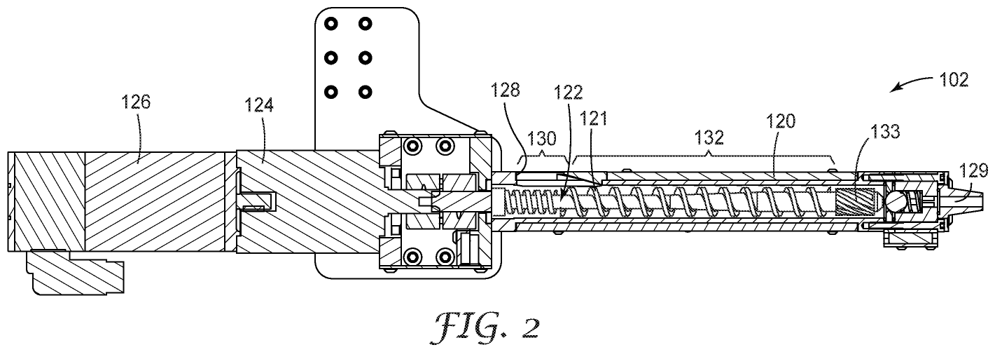

FIG. 2 shows in greater detail the dispensing apparatus 102 of FIG. 1. As shown, the dispensing apparatus 102 includes a barrel 120 and a rotatable screw 122 received therein. A gearbox 124 and motor 126 together provide a drive mechanism operatively coupled to the screw 122. The drive mechanism powers the rotation of the screw 122 within the barrel 120 when the apparatus 102 is being operated. It is advantageous for the motor 126 to have a high torque limit causing it to stall above a set torque level to avoid breakage of the screw 122 if there is a clog during operation.

The barrel 120 contains one or more heating elements to heat the feed stock composition, such as a thermoplastic composition, above its melting temperature. Adjacent to one end of the screw 122 is an inlet 128 where the filament adhesive 108 can enter the apparatus 102 and become melted from thermal contact with the heated barrel 120 and shearing action imparted by the rotation of the screw 122 therein. On the opposite end of the screw 122, the barrel 120 has an outlet 129 aligned with a longitudinal axis 148 (shown in FIG. 4) of the screw 122, where the molten composition is continuously dispensed from the apparatus 102.

For effective operation, it is desirable for the screw 122 to be closely meshed with the inner surfaces of the barrel 120, with sufficient clearance to allow rotation of the screw 122 enable its insertion and removal from the barrel 120. During operation, this clearance accommodates a small amount of molten composition, thereby providing a liquid seal against the barrel 120. As illustrated, the screw 122 is subdivided into several sections, including a first section 130 adjacent to the inlet 128 of the barrel 120 and a second section 132 located distal to the first section 130 and extending toward the outlet 129 of the barrel 120. Optionally and as shown, the screw 122 further includes a mixing section 133 connected to the distal end of the second section 132 and adjacent to the outlet 129.

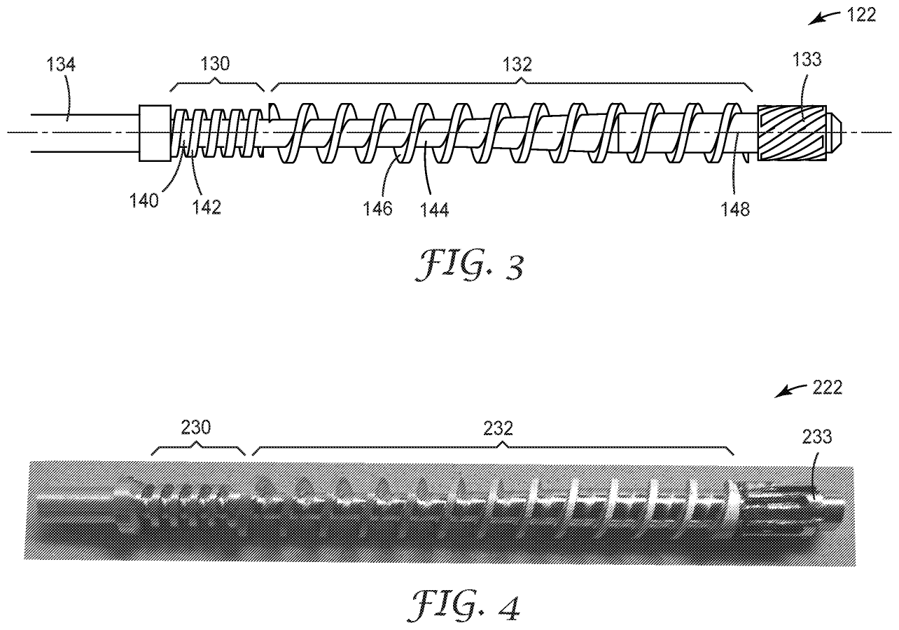

Further details concerning the structure of the screw 122 are provided below in reference to FIG. 3, which shows the screw 122 disassembled from the remaining components of the apparatus 102. In the order provided, this figure reveals a shank end 134 of the screw 122 for connection to the motor 126 and gearbox 124, first and second sections 130, 132, and mixing section 133. The first section 130 is comprised of a first shaft 140 with a first helical flight 142 disposed thereon. The second section 132 is comprised of a second shaft 144 with a second helical flight 146 disposed thereon. The first and second helical flights 142, 146 may or may not be connected with each other. Further, in some embodiments, more than one helical flight can be present on either or both of first and second sections 130, 132. Multiple interlaced helical flights can be advantageous when higher pitch is desired and when gaps between flights want to be kept to a minimum.

The first shaft 140 and second shaft 144 generally have axial symmetry about a common longitudinal axis 148. The radius, or girth, of the shafts 140, 144 can be approximately constant along some portions of the sections 130, 132 and generally increase over other portions of the sections 130, 132. In the embodiment shown in FIG. 3, the radius of the first shaft 140 is approximately constant along its length. By contrast, the radius of the second shaft 144 is approximately constant over a first portion of its length, increases to a significantly larger radius over a second portion of its length, and is then approximately constant at the larger radius over a third portion of its length. Tapering of the second shaft 144 can help force mixing and melting of the composition build up pressure within the barrel to expel the melt from the outlet.

Each of the first helical flight 142 and second helical flight 146 have an approximately constant radius along the length of its respective section 130, 132. As shown, however, the first helical flight 142 has a radius significantly smaller than that of the second helical flight 146. The first helical flight 142 can have a nominal outer radius that is from 50% to 90%, from 60% to 85%, from 70% to 80%, or in some embodiments, less than, equal to, or greater than 50%, 55, 60, 65, 70, 75, 80, 85, or 90% of the nominal outer radius of the second helical flight 146. If % difference is too low, then the nipping phenomenon will not be observed. If the % difference is too high, the inlet flights will be so shallow that the screw strength may be compromised and make it more susceptible to breaking.

Depending on the size of the screw 122, the absolute difference in radius between the first helical flight 142 and the second helical flight 146 can be from 0.5 millimeter to 19 millimeters, from 3 millimeters to 15 millimeters, from 5 millimeters to 12 millimeters, or in some embodiments, less than, equal to, or greater than 0.5 millimeter, 1, 2, 3, 4, 5, 6, 7, 8, 9, 10, 11, 12, 13, 14, 15, 16, 17, 18, or 19 millimeters.

In some embodiments, the first helical flight 142 has a pitch that is shorter than that of the second helical flight 146, where pitch is defined as the center-to-center distance between two consecutive turns of the same flight along a direction parallel to the longitudinal axis 148. The first helical flight 142 can have a pitch that is from 10% to 99%, from 25% to 75%, or from 40% to 60%, or in some embodiments, less than, equal to, or greater than 10%, 15, 20, 25, 30, 35, 40, 45, 50, 55, 60, 65, 70, 75, 80, 85, 90, 95, 99 or 100% of the pitch of the second helical flight 146. If the inlet pitch is too low, the filament may be pulled in too slowly, and limit maximum throughput. If the inlet pitch is too high, the rest of screw cannot keep up, the filament is overfed, and a rolling ball forms, which can stop the feeding process.

The screw 122 need not be exclusively comprised of the first and second sections 130, 132. For example, although not shown here, the screw 122 could further include a transition section that connects the first and second sections to each other. In an exemplary embodiment, each of the first and second sections has a generally constant flight radius, and the screw further comprises a third section having a flight radius that is tapered to provide a smoother transition from the flight of the first section to that of the second section.

The first section 130 generally extends along most or all of the portion of the screw 122 adjacent to the inlet 128 of the barrel 120. In a preferred embodiment, the first section 130 extends somewhat beyond the inlet 128, so that it can function to pack the filament into the barrel. Optionally, the inlet 128 allows the filament to ride on top of the screw without being packed in. The first section 130 is generally shorter than the second section 132, and can have a length that is from 2% to 25%, from 5% to 20%, from 9% to 15%, or in some embodiments, less than, equal to, or greater than 2%, 3, 4, 5, 6, 7, 8, 9, 10, 11, 12, 13, 14, 15, 16, 17, 18, 19, 20, 21, 22, 23, 24, or 25% of the overall length of the screw 122. The length of the first section 130 can be at least 80%, at least 90%, or at least 100% that of the inlet 128.

When the screw 122 is rotating within the barrel 120, the radius of the first helical flight 142 is generally sized so that a continuous feedstock, such as a filament composition, can be effectively gripped between the outer surfaces of the first helical flight 142 and the inner surface of the barrel 120. In the apparatus 102, the clearance, or gap, between these opposing surfaces is preferably smaller than the diameter of a filament composition to be fed into the inlet 128 of the barrel 120. This spacing allows for the filament composition to be aggressively pulled into the inlet 128 at a consistent speed as the screw 122 rotates during operation of the apparatus 102.

Proper sizing of the first helical flight 142 is generally dependent on the dimensions of the feedstock. It can be advantageous for the gap between the first helical flight 142 and the barrel 120 to be from 5% to 100%, from 10% to 75%, from 20% to 50%, or in some embodiments, less than, equal to, or greater than 5%, 10, 15, 20, 25, 30, 35, 40, 45, 50, 55, 60, 65, 70, 75, 80, 85, 90, 95, or 100% of the filament diameter.

Control over the rate at which a filament composition is drawn into the barrel 120 by the screw 122 can be achieved by optimizing the pitch of the first helical flight 142. A primary advantage of the described configuration of the screw 122 and apparatus 102 more generally is that it enables a filament composition to be actively pulled into the apparatus 102 at a highly controlled rate while minimizing or eliminating risk of accidentally severing or losing grip on the filament composition. Since the apparatus 102 is self-metering, there is no need for a provide an external motorized feeding system. This configuration was also found to substantially decrease the rate of jamming of the filament adhesive near the inlet 128 as a result of a mismatch between the rate of feeding and rate of consumption.

FIG. 4 shows a screw 222 according to a similar embodiment to that shown in FIG. 1, except the screw 222 uses a different Maddock-type mixing section 233. Like the previous mixing section 133, this component is intended to force the full melting of the composition before it is expelled from the dispenser. It is to be understood, however, that any other type of mixing section could be used, either alternatively or in combination. For example, the mixing section could be based on a plurality of cylindrical posts or densely flighted screw sections with crosscuts (as found in Saxton mixers), or any of a variety of known post patterns, including those used for pineapple mixers. Optionally, posts or pins may be disposed on the interior sidewalls of the barrel and aid in the mixing process. Crosscuts may be present in the flights of the screw to avoid interference. Other aspects of the screw 222 are essentially analogous to those already shown and described with respect to screw 122 and shall not be repeated here.

Other variants are possible. For example, the screw could have a hollow configuration as described in co-pending U.S. Provisional Patent Application No. 62/994,633 (Chastek, et al.). The screw could also be modified to include gripping lugs formed on the flights of the first section as described in published International Patent Publication No. WO 2020/174394 (Napierala, et al.). Various coatings, including metallic coatings comprised of steel, chrome, or aluminum, are known in the art can be disposed on screw surfaces to provide crack and corrosion resistance as known in the art.

### Examples

Objects and advantages of this disclosure are further illustrated by the following non-limiting examples, but the particular materials and amounts thereof recited in these examples, as well as other conditions and details, should not be construed to unduly limit this disclosure.

Unless otherwise noted, all parts, percentages, ratios, etc. in the Examples and the rest of the specification are by weight.

TABLE 1
Materials

| Designation | Description | Source |
|---|---|---|
| D1161 | A styrene-isoprene-styrene triblock copolymer having | Kraton Performance |
| | an approximate styrene content of 15% and 19% | Polymers, Houston, TX, |
| | diblock content, available under the trade designation | United States |
| | KRATON D1161 P | |
| P140 | A fully hydrogenated hydrocarbon resin with a | Arakawa, Osaka, Japan |
| | softening point of 140° C., available under the trade | |
| | designation ARKON P-140 | |
| LBR361 | A butadiene homopolymer with glass transition | Kuraray America, |
| | temperature of -49 degrees Celsius, available under the | Incorporated, Houston, TX, |
| | trade designation KURARAY LBR-361 | United States |
| IRG1010 | Pentaerythritoltetrakis(3-(3,5-ditertbutyl-4- | BASF Corporation, |
| | hydroxyphenyl)propionate), an antioxidant available | Florham Park, NJ, United |
| | under the trade designation IRGANOX 1010 | States |
| EVA-CB | A pelletized ethyl vinyl acetate containing carbon black | Clariant Corporation, |
| | at a concentration of 40 wt %, available under the trade | Holden, MA, United States |
| | designation REMAFIN Black EVA 40% | |
| NA217000 | A low-density polyethylene resin available under the | Lyondell Basell, Houston, |
| | trade designation Petrothene NA217000 | TX, United States |

### Test Methods

### Throughput Measurement Test:

The dispenser temperature was set to 200 degrees Celsius and allowed to equilibrate for at least 10 minutes. The dispenser was oriented such that the inlet orifice faced down and was unobstructed, and filament was fed from a barrel located below the dispenser. Feeding of filament was initiated by manually inserting filament into the inlet orifice, while rotating the screw at 80 revolutions per minute. Dispensing was carried out for at least one minute to ensure the barrel was filled with adhesive. The molten adhesive exiting the distal end of the dispenser was collected in aluminum pans and weighed. Samples were collected for 30 seconds. Between collected samples, the dispenser was stopped for 30 seconds. A total of five samples were collected continuously, with the screw stopped for 30 seconds between collections, with the throughput reported in kilograms per hour (kg/h). The standard deviation among the five throughput samples was also reported in kilograms per hour. The standard deviation should be <10% of the throughput to ensure the dispenser throughput rate is sufficiently reproducible.

### Feed Gripping Test:

The dispenser temperature was set to 200 degrees Celsius and allowed to equilibrate for at least ten minutes. The dispenser was oriented such that the inlet orifice faced down and was unobstructed, and was 1.45 meters above a weight holding platform. A 2-meter-long section of filament was prepared with a 10 cm radius loop tied in the filament at one end. A 1-kilogram weight was attached to this loop and placed on the weight holding platform. Filament feeding was initiated by turning the screw at 80 RPM, and manually pushing the end of filament without the knot and weight, into the inlet orifice. A timer was initiated once the filament was sufficiently fed into the dispenser to the point that all slack was removed between the 1-kilogram weight and the dispenser. The feeding continued and was monitored for 60 seconds. If the dispenser successfully continued to pull filament into the inlet, while maintaining at least 50% of the throughput rate, it was considered a passing condition. A passing condition may involve lifting the 1-kilogram weight off of the weight holding platform, or the filament may stretch. It is understood that a passing condition could consist of a combination of both lifting the weight and filament stretching, and the exact result will depend on the filament durometer and diameter. On the other hand, if the filament fell out of the dispenser within 60 seconds, it was a failure. A failure may be caused an inability of the screw to grip the filament, or a rolling ball forming. In some cases, the screw may grip the filament too lightly to remove slack in the filament, yet the tackiness of the filament may prevent it from falling out. In this situation, the filament feeding was manually assisted until the 1-kilogram weight was 30 centimeters above the weight holding platform, without any slack in the filament. The 1-kilogram weight was slowly released to tension the filament allowing the test to begin. During the Feed Gripping Test, no external feeding or gripping mechanisms were used. The test was run three times, and three consecutive passing values were required to consider the screw design to have desirable feed gripping strength.

### Preparatory Example 1 (PE1)

### Preparation of Polymodal Asymmetric Block Copolymer (PASBC)

A polymodal, asymmetric star block copolymers (“PASBC”) was prepared according to Example 1 of U.S. Pat. No. 5,393,787 (Nestegard et al.), the subject matter of which is hereby incorporated by reference in its entirety. The polymer had a number average molecular weight of about 4,000 Daltons and about 21,500 Daltons for the two end blocks, 127,000-147,000 Daltons for the arm, and about 1,100,000 Daltons for the star measured by SEC (size exclusion chromatography) calibrated using polystyrene standards. The polystyrene content was between 9.5 and 11.5 percent by weight. The mole percentage of high molecular weight arms was estimated to be about 30%.

### Preparation of the Core-Sheath Filaments

Compositions (material quantities are in weight percent) for the filament is represented in Table 2. Further description of techniques and processes to assemble filament constructions are contained in PCT Patent Publication No. 2019/1646798 (Nyaribo et al). The core adhesive raw materials were compounded in a 30 mm Steer twin screw dispenser operating at 212° C. A Zenith gear pump was used to push molten adhesive through a heated hose with 25 mm inner diameter and length of 2.4 meters. The molten adhesive was dispensed through the center orifice of a coaxial die into a 30° C. water bath and manually wound into fiber drums. Core-sheath filaments were made with 8 mm+1 mm diameter. The sheath material was fed in using a 30 mm single screw dispenser set to 204° C. and dispensed through the outer ring orifice of the coaxial die.

TABLE 2
Compositions of Filament

| | D1161 | PASBC | P140 | LBR361 | IRG1010 | EVA-CB | NA217000 | Filament |
|---|---|---|---|---|---|---|---|---|
| | (pbw) | (pbw) | (pph) | (pph) | (pph) | (pph) | (pph) | Diameter |
| Filament | Core | | | | | | Sheath | (mm) |
| PE1 | 41.1 | 13.4 | 34.6 | 5.8 | 1 | 0.1 | 4 | 8 |

### Example 1 and Comparative Example 1 (EX1 and CE1)

### Dispensing of the Adhesive

Core-sheath filaments as assembled in PE1 were fed directly out of a fiber drum into a dispensing head. The dispensing head contained either a screw (EX1) or a comparative screw (CE1) both of which were fabricated as further defined below. The Throughput Measurement Test was carried out on both EX1 and CE1 screws loaded into the dispense head. Throughput measurement test results are recorded in Table 3.

The dispenser with EX1 and CE1 were also subjected to the Feed Gripping Test, and the results are reported in Table 3.

TABLE 3
Throughput Measurements Test Results (at 215° C.)

| | EX1 | CE1 |
|---|---|---|
| Throughput, kg/h | 2.0 | N/A* |
| Standard deviation, kg/h | 0.1 | N/A* |
| % standard deviation | 5% | N/A* |
| Feed Gripping Test Result | PASS | FAIL |

*CE1 could not successfully grip and pull filament into the barrel, so no throughput measurements were made.
N/A— not applicable

### EX1 Screw Fabrication:

A 262 millimeter (mm) long screw with a radius of 9.5 mm as represented in FIG. 3 and FIG. 4 was machined in a computer numerical controlled (CNC) four-axis vertical endmill. The machining process was performed on a solid cylinder of aluminum 6061, with a radius of 9.5 mm. Single channels were made to define flights, with the channel width defined by endmill cutters with radii of 1.55 mm (0.0625 inches) for the first section 130 and the Maddock mixer, and 4.75 mm (0.0187 inches) for the second section 132. The pitch (i.e., height-to-height distance between flights) of the first section was 6 mm and the pitch of the second section was 12.5 mm. The screw shank was 35 mm long with a 6 mm radius. The first section extended from 45 mm to 77 mm from the shank end and had an outer radius (flight height) of 7 mm. The first section screw root radius (radius minus the height of flights) was 4.45 mm. The second section had a flight outer radius of 9.5 mm. When measured from the shank end, the second section root radius was 4.45 mm from 77 mm to 140 mm, and it increased to 6.7 mm from 140 mm to 190 mm. Between 190 and 232 mm, the second section root radius was 6.7 mm. The spiral Maddock mixer was located from 232 to 257 mm. The pitch was 100 mm. The flights were defined with a single 3.1 mm channel, making a 6.7 mm root radius. Eight evenly spaced parallel spiral channels were made, with openings alternating between shank and distal ends, as is expected in the spiral Maddock mixer design. The Maddock mixer flight outer radius was 9 mm.

### CE1 Comparative Screw Fabrication:

A comparative screw was fabricated for comparison. It had a similar design as EX1, with the main distinction being that it did not have the first section 130 flights. That is, it was made in the conventional way, with only the second section 132.

A 262 mm long screw with a radius of 9.5 mm was machined in a computer numerical controlled (CNC) four-axis vertical endmill. The machining process was performed on a solid cylinder of aluminum 6061, with a radius of 9.5 mm. Single channels were made to define flights, with the channel width defined by endmill cutters with radii of 1.55 mm (0.0625 inches) for the Maddock mixer, and 4.75 mm (0.0187 inches) for the second section 132. The second section 132 pitch is 12.5 mm. The screw shank was 35 mm long and 6 mm radius. The second section 132 extended from 45 mm to 232 mm from the shank end. The second section 132 had flight outer radius of 9.5 mm. When measured from the shank end, the second section 132 root radius was 4.45 mm from 45 mm to 107 mm, and it increased to 6.7 mm from 107 mm to 170. Between 170 and 232 mm, the second section 132 root radius stayed at 6.7 mm. The spiral Maddock mixer was located from 232 to 257 mm. The pitch was 100 mm. The flights were defined with a single 3.1 mm channel, making a 6.7 root radius. Eight evenly spaced parallel spiral channels were made, with openings alternating between shank and distal ends, as is expected in the spiral Maddock mixer design. The Maddock mixer flight outer radius was 9 mm.

### Barrel Fabrication:

An aluminum block (63.5 mm×38.1×76.2 mm), which represents the shank end of the barrel, was used for the inlet section of the barrel. A 9.5 mm radius hole was cut through the central longest axis, to establish the main barrel axis. Threads were cut into the block to accept a schedule 80 aluminum ¾ inch NPT pipe nipple, that was 152.4 mm long, along the main barrel axis. A second aluminum block (38.1 mm×38.1 mm×25.mm), which represents the distal end of the barrel, was made and a 9.5 mm radius hole was cut through the central shortest axis. Threads were cut into the shortest axis, to connect to the other end of the NPT pipe nipple. The distal end of the second block had a 1.6 mm radius orifice and acted as the exit nozzle. An additional machining step to bore the inner radius of the main barrel axis to 9.6 mm was carried out. The inlet orifice was cut directly above the main barrel axis in block 1. A 4.8 mm radius end mill cutter was used to make a channel that was 9.5 mm wide and 19.1 mm long. The channel started 12.5 mm to 31.6 mm from the distal end of the barrel. The inlet orifice had straight sides, and no bevel. Its major axis was directly centered above the main barrel axis.

The barrel was attached to a combination of a 200W AC servo motor with 25:1 planetary gearbox using 2 aluminum plates (9.5 mm×38.1 mm×100 mm). The extruder screw shank was connected to the gear box shaft using a motor coupler. Resistive band heaters and a thermocouple were used in combination with a PID temperature controller to bring the dispenser to 200 degrees Celsius.

### Dispense System Component Fabrication:

Other dispense system components were assembled according to fabrication techniques described in co-pending U.S. Provisional Patent Application No. 62/810,248 (Napierala et al).

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. An extrusion screw comprising:
a shaft having a shank end for connection to a drive mechanism and a distal end opposite the shank end;
a first helical flight extending around a first section of the extrusion screw; and
a second helical flight extending around a second section of the extrusion screw, wherein the second section is located distal to the first section and wherein the first helical flight has a nominal outer radius less than that of the second helical flight.

2. The extrusion screw of claim 1, wherein the first helical flight has a nominal outer radius that is 50% to 90% of that of the second helical flight.

3. The extrusion screw of claim 2, wherein the first helical flight has a nominal outer radius that is 60% to 85% of that of the second helical flight.

4. The extrusion screw of claim 3, wherein the first helical flight has a nominal outer radius that is 70% to 80% of that of the second helical flight.

5. The extrusion screw of any one of claim 1, wherein a difference in radius between the first helical flight and the second helical flight is from 1 millimeter to 19 millimeters.

6. The extrusion screw of claim 5, wherein a difference in nominal outer radius between the first helical flight and the second helical flight is from 3 millimeters to 15 millimeters.

7. The extrusion screw of claim 6, wherein the difference in nominal outer radius between the first helical flight and the second helical flight is from 5 millimeters to 12 millimeters.

8. The extrusion screw of claim 1, wherein the first helical flight has a pitch shorter than that of the first helical flight.

9. The extrusion screw of claim 8, wherein the first helical flight has a pitch that is 10% to 99% of that of the second helical flight.

10. The extrusion screw of claim 9, wherein the first helical flight has a pitch that is 25% to 75% of that of the second helical flight.

11. The extrusion screw of claim 10, wherein the first helical flight has a pitch that is 40% to 60% of that of the second helical flight.

12. The extrusion screw of claim 1, wherein each of the first and second sections has a generally constant flight radius, and wherein the shaft further comprises a third section and a third helical flight thereon with a flight radius tapered to provide a transition from the first helical flight to the second helical flight.

13. The extrusion screw of claim 1, wherein the first section has a length that is from 2% to 25% of an overall length of extrusion screw.

14. The extrusion screw of claim 13, wherein the first section has a length that is from 5% to 20% of the overall length of extrusion screw.

15. The extrusion screw of claim 14, wherein the first section has a length that is from 9% to 15% of the overall length of extrusion screw.

16. An apparatus for dispensing a composition, the apparatus comprising:
a barrel having an inlet and outlet;
the extrusion screw of claim 1; and
the drive mechanism operatively coupled to the shank end.

17. A method of dispensing a composition using the apparatus of claim 16, the method comprising:
feeding the composition into the inlet of the barrel;
rotating the extrusion screw such that the first helical flight pulls the composition through the inlet into the first section of the barrel and the second helical flight conveys the composition through the second section where it is melted and expelled through the outlet.

18. The method of claim 17, wherein the composition comprises a filament composition.

19. The method of claim 18, wherein a gap between the first helical flight and the barrel is from 5% to 100% of the filament diameter.

20. The method of claim 19, wherein the filament diameter is from 20% to 50% greater than the gap between the first helical flight and the barrel.
